(19) United States
(12) Patent Application Publication
(10) Pub. No.: US 2005/0122327 A1
(43) Pub. Date: Jun. 9, 2005

(54) Method and system for designing fonts

(76) Inventor: Geoffrey W. Greve, Mendon, MA (US)

Correspondence Address: PEPPER HAMILTON LLP, ONE MELLON CENTER, 50TH FLOOR, 500 GRANT STREET, PITTSBURGH, PA, 15219, US

(21) Appl. No.: 10/869,087

(22) Filed: Jun. 16, 2004

Related U.S. Application Data
(60) Provisional application No. 60/528,261, filed on Dec. 8, 2003.

(51) Int. Cl. G06T 11/00

(52) U.S. Cl. 345/467

(57) ABSTRACT

A method and system for defining a font character set for a display and for designing an electric writeable display using such a font character set is disclosed. A developer can create a font character set including a plurality of characters. The characters are overlapped within a bounded area in order to create a character mask. The character mask is composed of individual segments required to display one or more of the characters in the font character set. Activating one or more segments may display a character in the font character set. The method can be implemented in a system including a processor, a display, and a computer-readable storage medium containing instructions for one or more computer programs. Electrodes shaped and placed based on the segments of the character mask are used to implement an electric writeable display incorporating a font character set.

### PRIORITY CLAIM

This application claims priority to and incorporates by reference U.S. Provisional Application No. 60/528,261, entitled “Method and System for Designing Fonts” and filed Dec. 8, 2003.

### TECHNICAL FIELD

This invention relates generally to the field of visual displays. The invention specifically relates to a method and system for designing fonts for visual displays. More specifically, the invention relates to a method and system for designing fonts having a relatively low number of discrete segments within a visual display element.

### BACKGROUND

Traditional signs have been based upon printed materials, paper, plastic, metal, etc., and are therefore not programmable. Accordingly, they are not easily changed. In an attempt to overcome this problem, electronically programmable and/or controllable signs were developed and have been in existence for many years. For example, liquid crystal diode (LCD) displays, cathode ray tube (CRT) displays, and other electrically-addressable displays will display an image in response to applied electric signals or fields. However, such signs typically require a large amount of electricity, since they must provide illumination in order to be visible to a viewer.

Various types of electric writeable media, some of which are commonly known as rotatable element displays or electric paper displays, also exist in the prior art. One example of a rotatable element display includes a polymer substrate and bichromal rotatable elements such as balls or cylinders that are in suspension with an enabling fluid and are one color, such as white, on one side and a different color, such as black, on the other. Examples of such rotatable element displays are described in U.S. Pat. No. 5,723,204 to Stefik and U.S. Pat. No. 5,604,027 to Sheridon, each of which is incorporated herein by reference in its entirety. Under the influence of an electric field, the elements rotate so that either the white side or the black side is exposed.

Another type of electric writeable media is known as an electronic ink display, such as the one described in U.S. Pat. No. 6,518,949 to Drzaic, which is incorporated herein by reference. An electronic ink display includes at least one capsule filled with a plurality of particles made of a material, such as titania, and a dyed suspending fluid. When a direct-current electric field of an appropriate polarity is applied across the capsule, the particles move to a viewed surface of the display and scatter light. When the applied electric field is reversed, the particles move to the rear surface of the display and the viewed surface of the display then appears dark.

Yet another type of electric writeable media, also described in U.S. Pat. No. 6,518,949 to Drzaic, includes a first set of particles and a second set of particles in a capsule. The first set of particles and the second set of particles have contrasting optical properties, such as contrasting colors, and can have, for example, differing electrophoretic properties. The capsule also contains a substantially clear fluid. The capsule has electrodes disposed adjacent to it connected to a voltage source, which may provide an alternating-current field or a direct-current field to the capsule. Upon application of an electric field across the electrodes, the first set of particles move toward one electrode, while the second set of particles move toward the second electrode.

Other examples of electric writeable media include liquid crystal diode displays, encapsulated electrophoretic displays, and other displays.

Electric writeable displays have numerous advantages over conventional displays, such as LCDs and CRTs, since they are suitable for viewing in ambient light, they retain an image indefinitely in the absence of an applied electric field, and they can be made to be very lightweight and/or flexible. For further advantages of such displays, see U.S. Pat. No. 5,389,945 to Sheridon, incorporated herein by reference in its entirety. An example of such a display is a SmartPaper® display from Gyricon LLC.

Electric writeable displays can display information by applying an electric field to one or more portions of the electric writeable display in order to enable or disable elements in those portions of the display. Electrodes placed adjacent to the electric writeable display may be used to apply localized electric fields. Previous electric writeable displays were not designed to minimize the number of electrodes required to display a message. Generally, previous electric writeable displays used a large number of electrodes in order to provide a high level of granularity for the display because the displays were designed to be general-purpose instead of character-based displays.

Accordingly, one problem with previous electric writeable displays is that the high level of granularity increases the cost of the display and/or the time required to update the display depending upon whether the electrodes are fully mapped to electrode drivers or the electrodes are addressable by the electrode drivers. In the case of a display with fully mapped electrodes (i.e., an electrode driver for every electrode), the cost is increased because of the large number of electrodes and electrode drivers required by the display. In the case of addressable electrodes (i.e., the output of the electrode driver is mapped to one or more different electrodes based on an electrode “address” received by the electrode driver), the time to update an entire display is equal to the number of electrodes an electrode driver can drive multiplied by the time to charge and discharge an electrode. Thus, it is time consuming to update a display with addressable electrodes.

What is needed is a method of reducing the number of electrodes and electrode drivers required for an electric writeable display in order to reduce the cost of the display.

A further need exists for a method of designing fonts that reduce the number of electrodes and electrode drives required for an electric writeable display.

A further need exists for a method of designing a character element for an electric writeable display that can display characters from a font character set designed to reduce the number of electrodes and electrode drivers for each character element.

A further need exists for a method and system for designing display fonts in a manner that is portable between and among several types of displays.

The invention described herein is directed to solving one or more of the above-listed problems.

### SUMMARY

Before the present methods, systems and materials are described, it is to be understood that this invention is not limited to the particular methodologies, systems and materials described, as these may vary. It is also to be understood that the terminology used in the description is for the purpose of describing the particular versions or embodiments only, and is not intended to limit the scope of the invention which will be limited only by the appended claims.

It must also be noted that as used herein and in the appended claims, the singular forms “a,” “an,” and “the” include plural references unless the context clearly dictates otherwise. Thus, for example, reference to a “segment” is a reference to one or more segments and equivalents thereof known to those skilled in the art, and so forth. Unless defined otherwise, all technical and scientific terms used herein have the same meanings as commonly understood by one of ordinary skill in the art. Although any methods, materials, and devices similar or equivalent to those described herein can be used in the practice or testing of embodiments of the invention, the preferred methods, materials, and devices are now described. All publications mentioned herein are incorporated by reference. Nothing herein is to be construed as an admission that the invention is not entitled to antedate such disclosure by virtue of prior invention.

The description contained herein defines a method for designing a font that may be used to implement a character-based electric writeable display. The font may be designed to minimize the number of electrodes required to create an electric writeable display. Each electrode may be shaped and placed to affect the electric writeable display elements for one or more segments of a character element within the display. If an electrode affects a plurality of segments of a character element, the plurality of segments may always be active and inactive at the same time for any character in the font character set.

In an embodiment, a method of designing a character mask image for a display includes designing a plurality of font characters comprising all characters for a font character set, overlapping each of the plurality of font characters, and generating a character mask image including one or more segments based on the overlapped font characters. In an embodiment, the method further includes generating one or more control characters for a font character set, and adjusting the one or more control characters. In an embodiment, the method further includes determining whether one or more image errors exist, loading the character mask image into an error correction tool, correcting the one or more image errors in the character mask image, and storing the corrected character mask image. In an embodiment, the method further includes generating a boundary box bounding the character mask image, loading the boundary box and the character mask image into a character generation tool, generating a character list based on the font characters in the font character set, and defining one or more segments for each font character in the character list using the boundary box and the character mask image. The embodiment may further include creating a model of a circuit board including at least one character mask image. A segment may include one or more of a vertical stem, a horizontal stem, a rounded shape, and a round-to-square transition. The plurality of segments may include no more than 96 segments or, alternatively, no more than 64 segments.

In an embodiment, a system for designing a font character set for a display includes a processor, a computer-readable storage medium operably coupled to the processor, and a display. The computer-readable storage medium contains one or more instructions for performing a method of designing a font character set for the display including designing a plurality of font characters comprising all characters for a font character set, overlapping each of the plurality of font characters, and generating a character mask image including one or more segments based on the overlapped font characters. In an embodiment, the computer-readable storage medium further contains one or more instructions for generating one or more control characters for a font character set, and adjusting the one or more control characters. In an embodiment, the computer-readable storage medium further contains one or more instructions for determining whether one or more image errors exist, loading the character mask image into an error correction tool, correcting the one or more image errors in the character mask image, and storing the corrected character mask image. In an embodiment, the computer-readable storage medium further contains one or more instructions for generating a boundary box bounding the character mask image, loading the boundary box and the character mask image into a character generation tool, generating a character list based on the font characters in the font character set, and defining one or more segments for each font character in the character list using the boundary box and the character mask image. In the embodiment, the computer-readable storage medium may further contain one or more instructions for creating a model of a circuit board including at least one character mask image. A segment may include one or more of a vertical stem, a horizontal stem, a rounded shape, and a round-to-square transition. The plurality of segments may include no more than 96 segments, or, alternatively, no more than 64 segments.

In an embodiment, a method for designing an electric writeable display includes designing a character mask, including a plurality of segments, for a font character set, determining positions for one or more character locations on an electric writeable display, and, for each character location, defining locations for a plurality of electrodes. Each electrode may be shaped and positioned to match a segment of the character mask at the character location. In an embodiment, the method further includes generating a circuit board based on the defined locations for the plurality of electrodes for each of the one or more character locations. In an embodiment, the method further includes receiving display information from an input device, and displaying a message on an electric writeable display adjacent to the circuit board by providing power to electrodes on the circuit board, wherein the displayed message corresponds to the display information received from the input device. Each segment may be separated from its adjoining segments by at least approximately 0.015 inches. Each segment may have an internal diameter of at least approximately 0.011 inches.

Various aspects and applications will become apparent to the skilled artisan upon consideration of the brief description of the figures and the detailed description of the invention which follows.

### BRIEF DESCRIPTION OF THE DRAWINGS

Aspects, features, benefits and advantages of the embodiments will be apparent with regard to the following description and accompanying drawings where:

FIGS. 1A-C depict an exemplary process flow for designing a font character set according to an embodiment;

FIG. 2 depicts an exemplary character matrix used in the process of designing a font character set according to an embodiment;

FIG. 3 depicts an exemplary font character set and font design according to an embodiment;

FIG. 4 depicts an exemplary layering of characters in a font character set according to an embodiment;

FIG. 5A depicts an exemplary single layer including all characters in a font character set according to an embodiment;

FIG. 5B depicts an exemplary printed circuit board mask showing multiple character masks according to an embodiment;

FIG. 6 depicts an exemplary character matrix according to an embodiment;

FIG. 7 depicts an exemplary image to be corrected according to an embodiment;

FIG. 8 depicts an exemplary corrected character matrix and shared according to an embodiment;

FIG. 9 depicts the selected segments for an exemplary designated character “A” according to an embodiment;

FIG. 10 illustrates an exemplary report according to an embodiment;

FIG. 11 depicts an exemplary image board layout using a font character set with exemplary placement measurements according to an embodiment;

FIGS. 12A-C depict exemplary font character sets and designs; and

FIG. 13 depicts an exemplary system for producing font character sets according to an embodiment.

### DETAILED DESCRIPTION

This description relates to a method and system for designing fonts for visual displays.

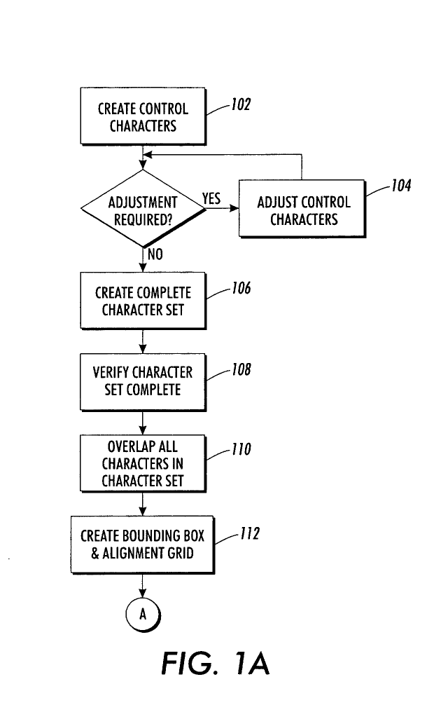

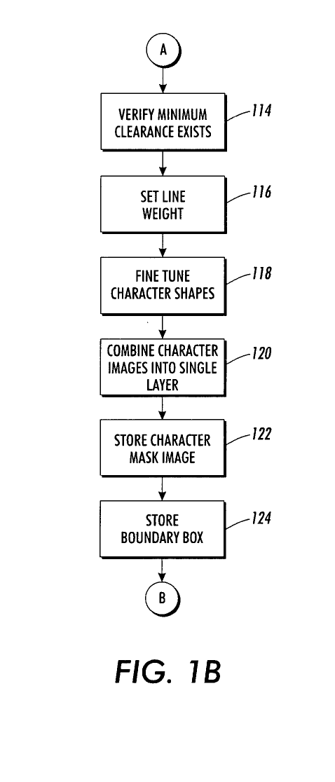

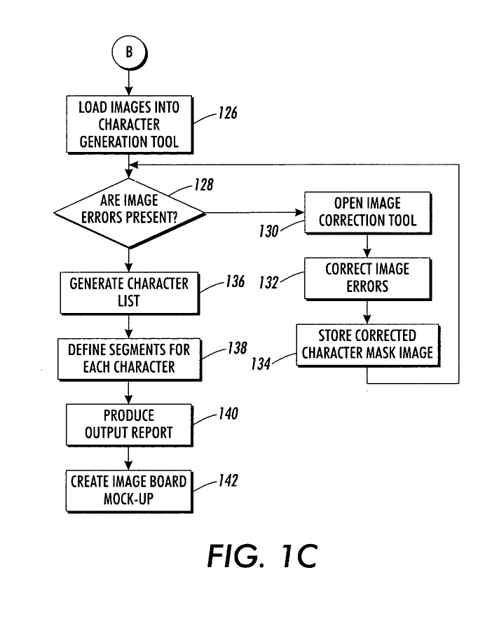

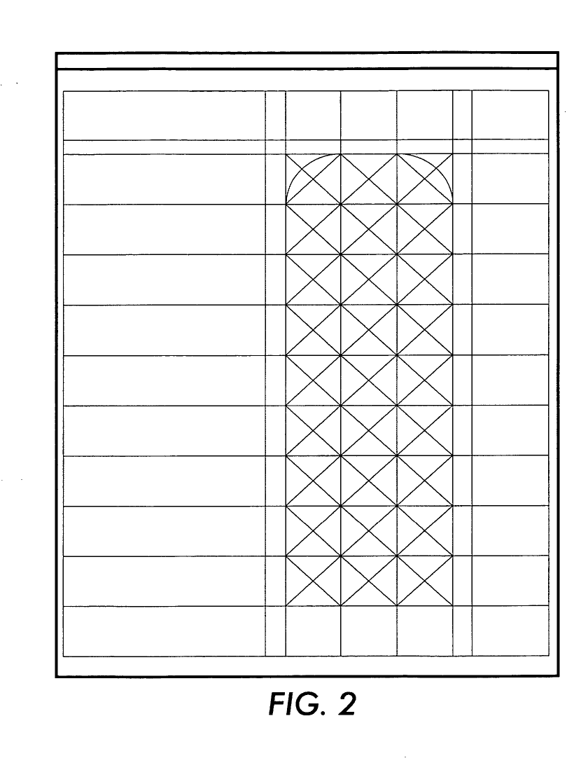

FIGS. 1A through 1C depict an exemplary process flow for designing a font character set according to an embodiment. This process flow is further described with reference to FIGS. 2-11.

FIG. 2 depicts an exemplary character matrix used in the process of designing a font character set according to an embodiment. As shown in FIG. 1A, a designer may create 102 a group of control characters displaying the key features in a font design using the character matrix. The key features may include vertical and horizontal stems, round shapes, round to square transitions, character heights and character weights. The designer may use a design tool such as Macromedia Fontographer® to create the control characters. The designer may adjust 104 the control characters prior to creating the characters for the remainder of the font character set.

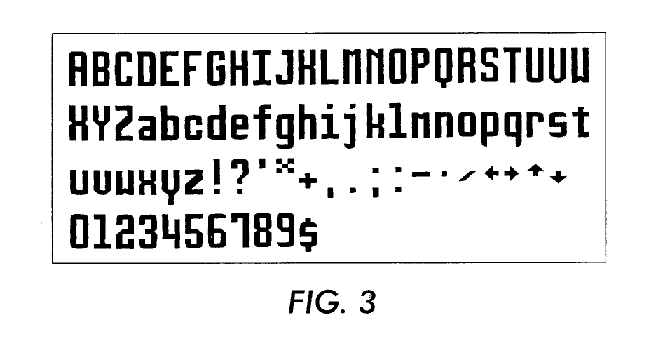

FIG. 3 depicts an exemplary font character set according to an embodiment. Once the design of the control characters is set, the designer may use a design tool to create 106 the remaining characters, as depicted in FIG. 1A. The designer may use the control characters as a guide during the creation process 106. Each font created by this process may have a customized character set. Once the full font character set is complete, the designer may examine 108 the balance, alignment and color of the font character set to verify that the full character set is properly formed. Each of the steps represented by reference numerals 102, 104 and 108 are optionally performed as part of creating a font character set.

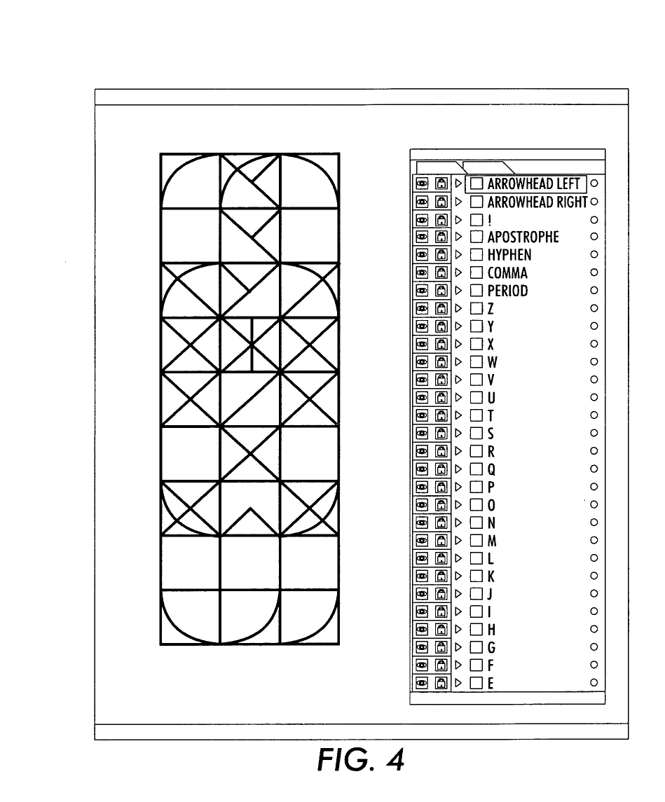

FIG. 4 depicts an exemplary layering of characters in a font character set according to an embodiment. As shown in FIG. 1A, the designer may load each character separately and overlap 110 the characters in a layering tool, such as Adobe Illustrator®. The designer may create 112 a boundary box and an alignment grid to ensure that each character is aligned appropriately. Referring to FIG. 1B, the designer may examine 114 a matrix formed by overlaying the characters to ensure that a minimum clearance exists for every segment. In an embodiment, the minimum clearance is approximately 0.015 inches. The designer may set 116 a line weight for the characters to a fixed value that enables bitmaps of the font character set to meet required tolerances. In an embodiment, the line weight is approximately 0.58 points (i.e., approximately 0.008 inches). the designer may adjust 118 individual character shapes to ensure that the overlapping character images do not produce extraneous gaps. In an embodiment, each segment has an area with a minimum diameter of approximately 0.011 inches. By setting the minimum diameter to 0.01 inches, the segment may accommodate a hole, or “via,” with a pad having a diameter of approximately 0.010 inches. The pad permits reception of an electrical signal when a layered font set is included on, for example, a printed circuit board (PCB).

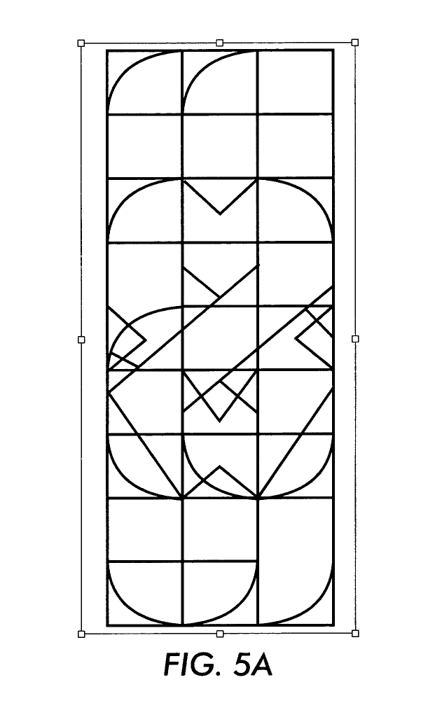

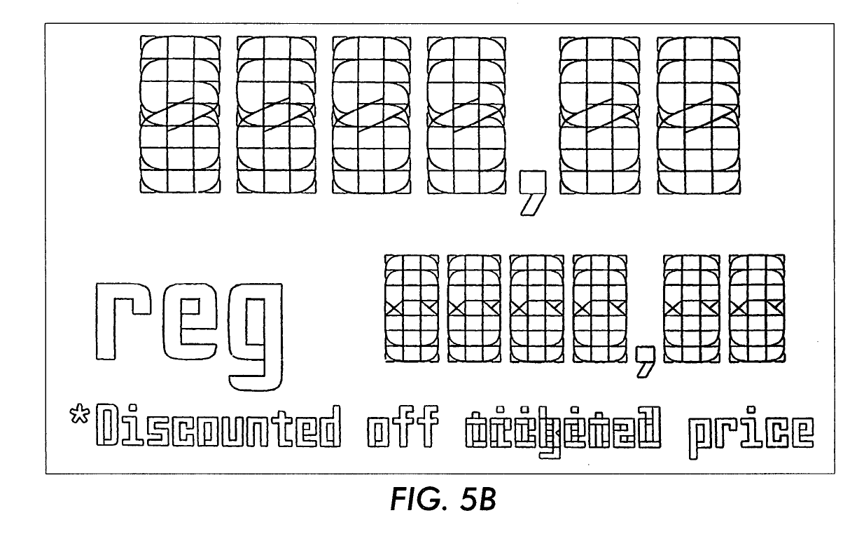

FIG. 5A depicts an exemplary single layer including all characters in a font character set according to an embodiment. As depicted in FIG. 1B, the designer may combine 120 character images for all characters into one layer using the layering tool. The designer may store 122 the layer as a character mask image for the font. The designer may also create and store 124 a second image (not shown in FIG. 5A) of an empty box large enough to encompass the length and width of each character in the font. The designer may store 122 and 124 the images, for example, as bitmaps at a resolution that is fine enough to produce a clear resulting image, but coarse enough to permit use of the layering tool. In an embodiment, the resolution is 1000 dpi (dots per inch).

The character mask image may be printed on a PCB or other backplane using any number of printing techniques, such as etching, sputtering or chemical deposition. A plurality of mask images may be included to provide a character set on the backplane. In operation, the backplane may direct electrical charge, through the vias, to selected segments that correspond to a desired character. An example of a PCB mask showing multiple character masks is shown in FIG. 5B. The backplane may connect to a writeable display medium so that the activation of a segment causes the medium to display an image corresponding to the segment.

In an embodiment, the font character matrix has no more than 96 segments so that a 96-bit electronic driver chip can selectively control each segment in the font character matrix. In an embodiment, the font may have no more than 64 segments. In such an embodiment, two driver chips may control three character matrices. Software may be used to direct the chip to activate appropriate character segments. For example, if a user selects the capital letter “A” using an appropriate input device, such as a computer keyboard or a mouse or other pointing device, that selection may cause one or more driver chips to activate the segments that, in combination, correspond to the capital letter “A” in the desired character matrix. The selection may ultimately cause the electric writeable display medium to react (such as by having balls twist at locations corresponding to the segments) and display a capital “A” at an insertion point.

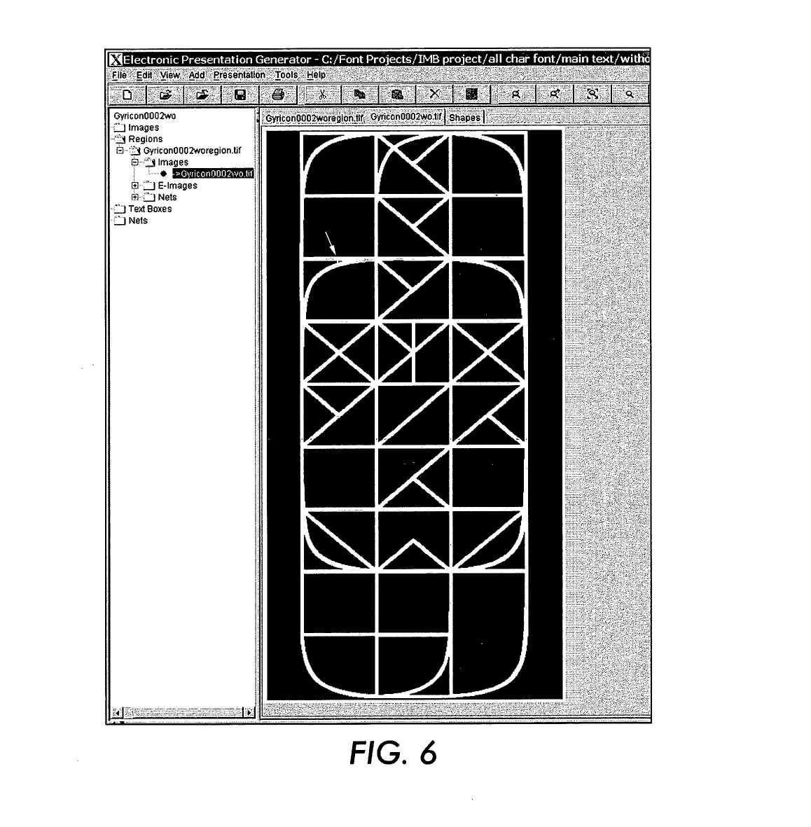

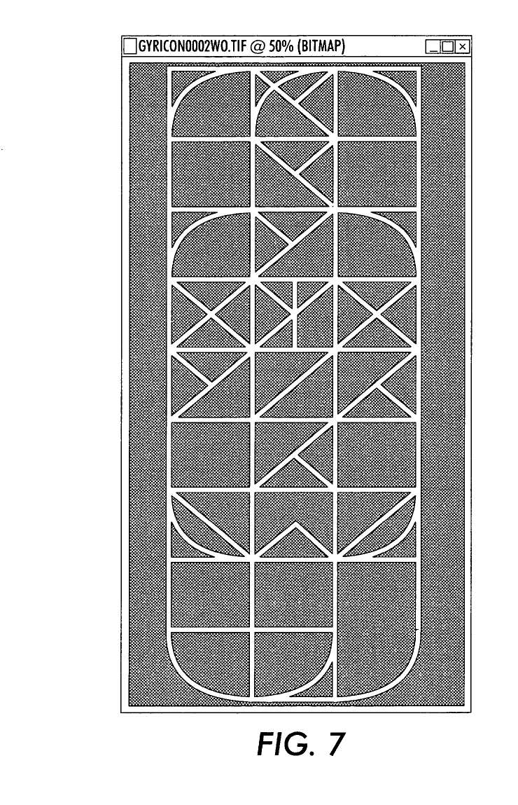

FIG. 6 depicts an exemplary character matrix according to an embodiment. Referring to FIG. 1C, the designer may load 126 the second image and the stored character mask image into a character generation tool, such as the Electronic Presentation Generator designed by Gyricon LLC. The designer may use the character generation tool to examine the character mask image for hanging pixels and/or unwanted segments caused by stray pixels forming unnecessary shapes, such as those shown in FIG. 7. Loading the second image prior to the character mask image may ensure that the designer can center the character mask image within the boundaries of the second image. The designer may convert the character mask image to a 72 dpi image that retains the quality of the original image after it has been loaded into the character generation tool. Moreover, the file colors may be reversed from black on white to white on black. Referring again to FIG. 1C, if any image errors are present 128, the designer may exit the character generation tool and open 130 the character mask image in an image correction tool, such as Adobe Photoshop®, which is made by Adobe Systems, Inc., as shown in FIG. 7. The designer may use the image correction tool to correct 132 errors in the image. The designer may store 134 the corrected character mask image following image correction.

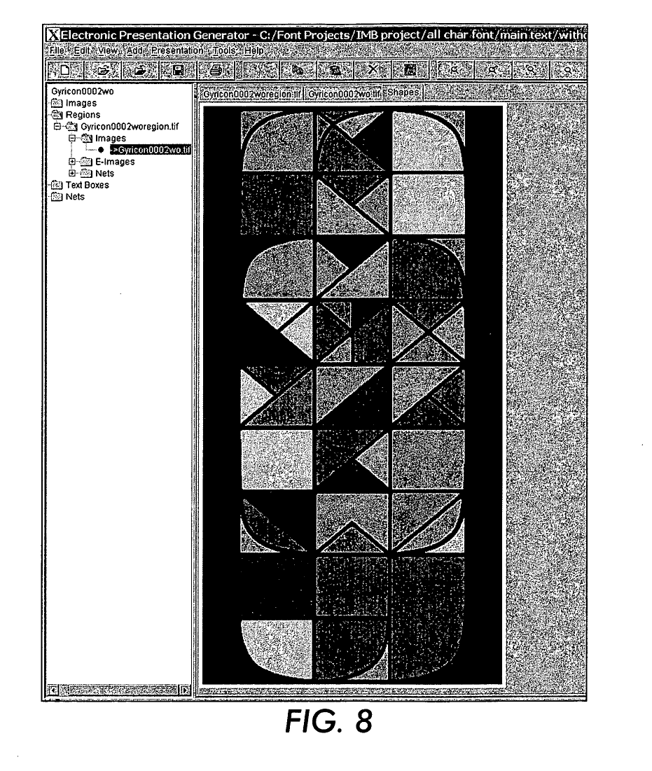

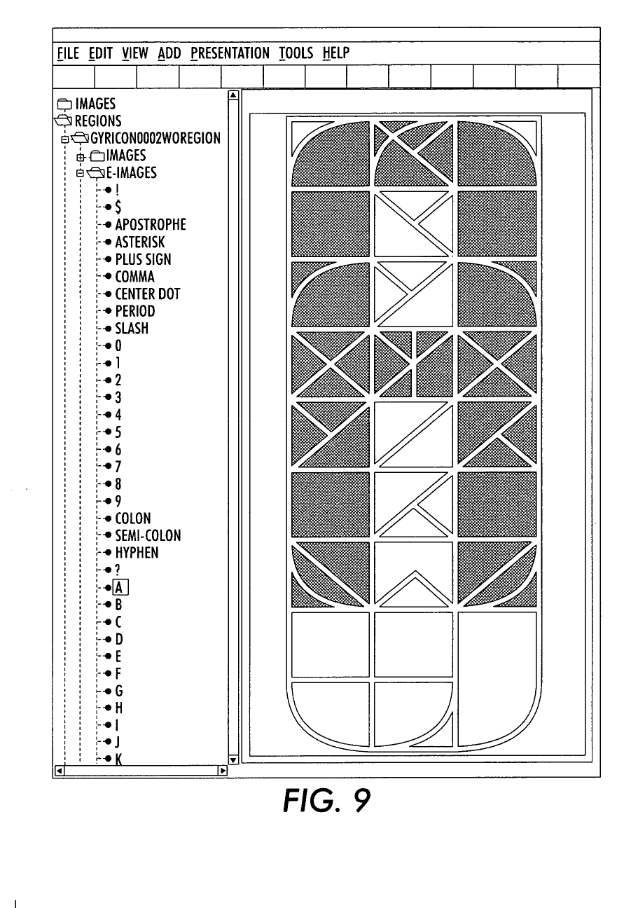

FIG. 8 depicts an exemplary corrected character matrix according to an embodiment. As shown in FIG. 1C, the designer may load 126 the second image and the corrected character mask image into the character generation tool. Again, loading the second image prior to loading the corrected character mask image may ensure that the character mask image is loaded within the boundaries of the second image. The character generation tool may generate 136 an e-image list of the characters to be defined in the character generation tool. The e-image list may include a designation for each character in a font character set. The designer may select 138 a designation for a particular character to determine the segments pertaining to the designated character. In an embodiment, the designer may select the segments for each designated character. For example, FIG. 9 depicts the selected segments for an exemplary designated character “A” for an exemplary font character set.

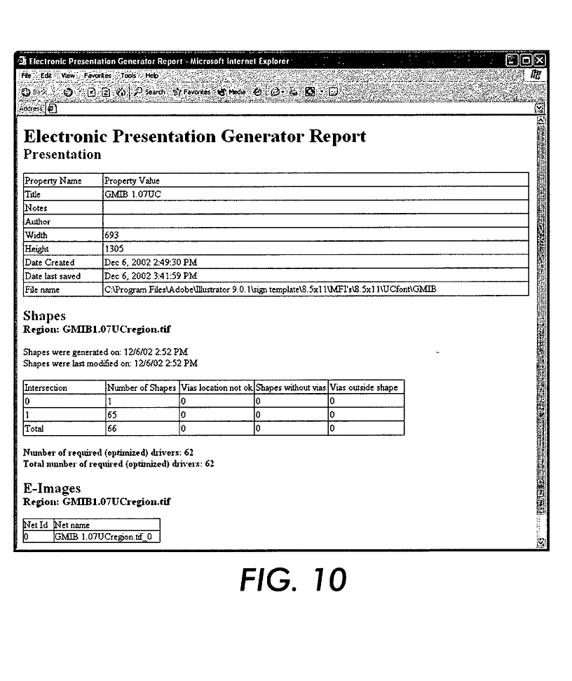

After the segments for each character designated in the e-image list for a particular font character set have been defined, the character generation tool may produce 140 a report providing information regarding the font character set, as shown in FIG. 1C. In an embodiment, the information includes the number of optimized drivers required to create all of the characters in a particular font character set. FIG. 10 illustrates an exemplary report according to an embodiment in which 62 drivers drive 66 shapes for the font character set.

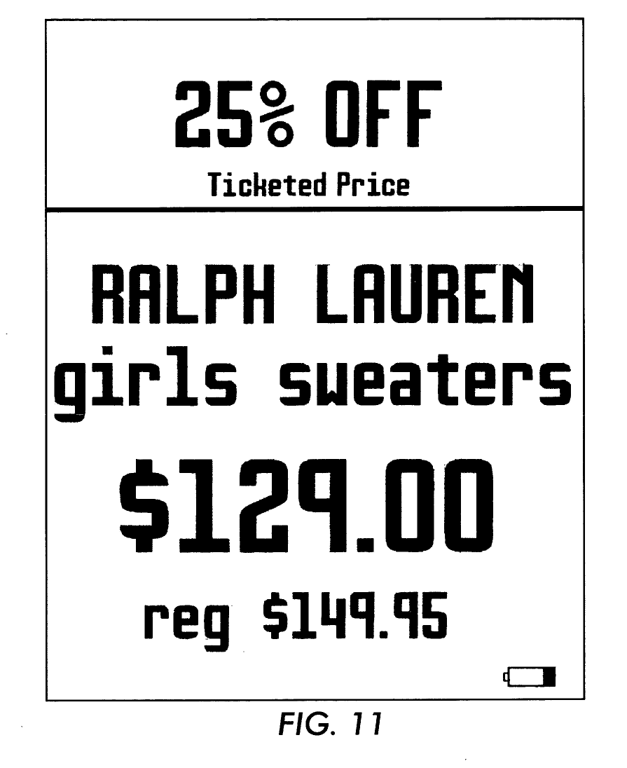

FIG. 11 depicts an exemplary image board layout with placement measurements using the font character set according to an embodiment. In an embodiment, as depicted in FIG. 1C, the designer may create 142 a to-scale mock-up of the image board by placing each line of text in the precise position that it would occupy on a manufactured image board. The design tool may record accurate measurements for the heights and widths of the characters, the distances between elements on the same line, and the distances between lines. The design tool may record additional measurements, such as the distance of an element from an edge of the image board, to assist in proper assembly of the board elements.

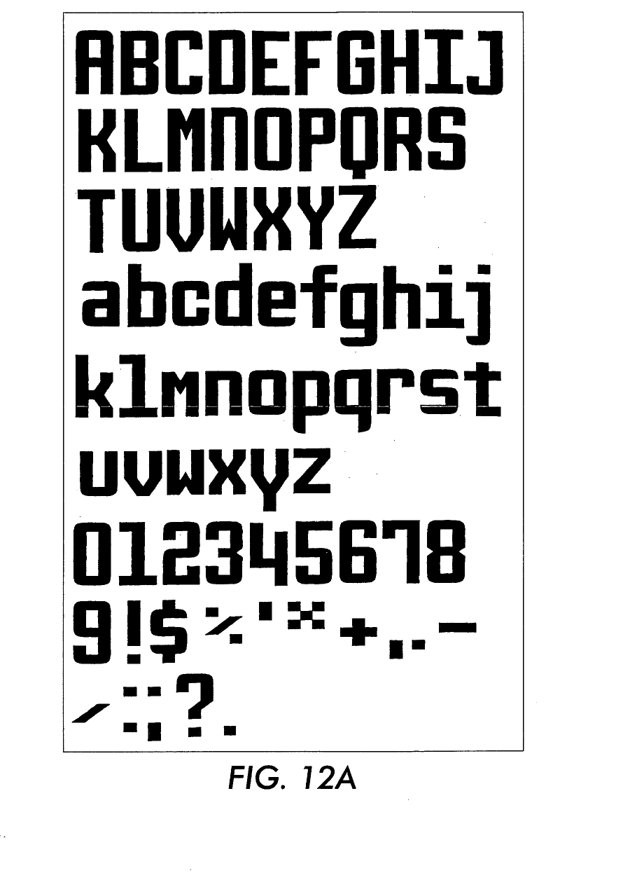

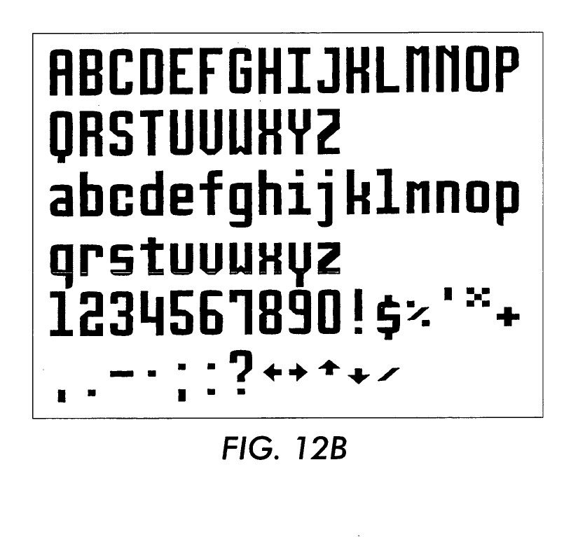

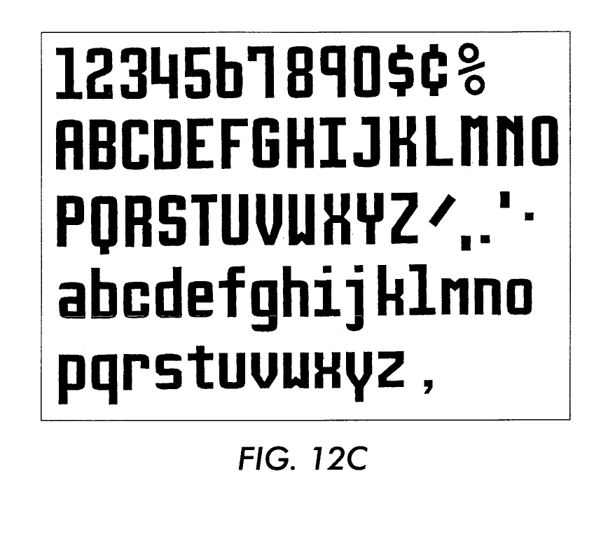

FIGS. 12A-C depict exemplary font character sets. The font character sets depicted are particularly useful because a low number of drivers are required to implement each character set.

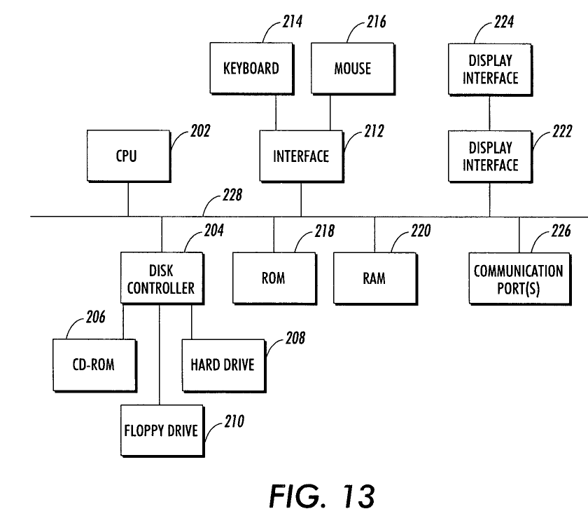

FIG. 13 is a block diagram of exemplary hardware that may contain and/or implement the program instructions of a system embodiment. Referring to FIG. 13, a bus 228 serves as the main information highway interconnecting the other illustrated components of the hardware. CPU 202 is the central processing unit of the system, performing calculations and logic operations required to execute a program. Read only memory (ROM) 218 and random access memory (RAM) 220 constitute memory devices.

A disk controller 204 interfaces one or more optional disk drives to the system bus 228. These disk drives may be external or internal floppy disk drives such as 210, external or internal CD-ROM, CD-R, CD-RW or DVD drives such as 206, or external or internal hard drives 208. As indicated previously, these various disk drives and disk controllers are optional devices.

Program instructions may be stored in the ROM 218 and/or the RAM 220. Optionally, program instructions may be stored on a computer readable carrier, such as a floppy disk or a digital disk, another recording medium, a communications signal, or a carrier wave.

Software applications for each of the design tool, the layering tool, the character generation tool, and the image correction tool may be stored in one or more of the disk drives connected to the disk controller 204, the ROM 218 and/or the RAM 220. Preferably, the CPU 202 may access the design tool, layering tool, character generation tool or image correction tool as required.

A display interface 222 may permit information from the bus 228 to be displayed on the display 224 in audio, graphic or alphanumeric format. Communication with external devices may optionally occur using various communication ports such as 226.

In addition to the standard computer-type components, the hardware may also include data input devices such as a keyboard 214 or pointing input devices 216 such as a remote control, pointer, mouse and/or joystick.

Although the invention has been described with reference to the disclosed embodiments, it will be apparent to one skilled in the art that variations and modifications are contemplated within the spirit and scope of the invention. The drawings and description of the disclosed embodiments are made by way of example rather than to limit the scope of the invention, and it is intended to cover within the spirit and scope of the invention all such changes and modifications.

1. A method of designing a character mask image for a display, the method comprising:
designing a plurality of font characters for a font character set;
overlapping each of the plurality of font characters; and
generating a character mask image including one or more segments based on the overlapped font characters.

2. The method of claim 1, further comprising:
generating one or more control characters for a font character set; and
adjusting the one or more control characters.

3. The method of claim 1, further comprising:
determining whether one or more image errors exist;
loading the character mask image into an error correction tool;
correcting the one or more image errors in the character mask image; and
storing the corrected character mask image.

4. The method of claim 1, further comprising:
generating a boundary box bounding the character mask image;
loading the boundary box and the character mask image into a character generation tool;
generating a character list based on the font characters in the font character set; and
defining one or more segments for each font character in the character-list using the boundary box and the character mask image.

5. The method of claim 4, further comprising:
creating a model of a circuit board including at least one character mask image.

6. The method of claim 1 wherein a segment comprises one or more of a vertical stem, a horizontal stem, a rounded shape, and a round-to-square transition.

7. The method of claim 1 wherein the plurality of segments comprises no more than 96 segments.

8. The method of claim 7 wherein the plurality of segments comprises no more than 64 segments.

9. A system for designing a font character set for a display, the system comprising:
a processor;
a computer-readable storage medium operably coupled to the processor; and
a display,
wherein the computer-readable storage medium contains one or more instructions for performing a method of designing a font character set for the display, the method comprising:
designing a plurality of font characters for a font character set;
overlapping each of the plurality of font characters; and
generating a character mask image including one or more segments based on the overlapped font characters.

10. The system of claim 9, wherein the computer-readable storage medium further contains one or more instructions for performing the following:
generating one or more control characters for a font character set; and
adjusting the one or more control characters.

11. The system of claim 9, wherein the computer-readable storage medium further contains one or more instructions for performing the following:
determining whether one or more image errors exist;
loading the character mask image into an error correction tool;
correcting the one or more image errors in the character mask image; and
storing the corrected character mask image.

12. The system of claim 9, wherein the computer-readable storage medium further contains one or more instructions for performing the following:
generating a boundary box bounding the character mask image;
loading the boundary box and the character mask image into a character generation tool;
generating a character list based on the font characters in the font character set; and
defining one or more segments for each font character in the character list using the boundary box and the character mask image.

13. The system of claim 12, wherein the computer-readable storage medium further contains one or more instructions for performing the following:
creating a model of a circuit board including at least one character mask image.

14. The system of claim 9 wherein a segment comprises one or more of a vertical stem, a horizontal stem, a rounded shape, and a round-to-square transition.

15. The system of claim 9 wherein the plurality of segments comprises no more than 96 segments.

16. The system of claim 15 wherein the plurality of segments comprises no more than 64 segments.

17. A method for designing an electric writeable display, the method comprising:
designing a character mask for a font character set, wherein the character mask includes a plurality of segments;
determining positions for one or more character locations on an electric writeable display; and
for each character location, defining locations for a plurality of electrodes, wherein each electrode is shaped and positioned to match a segment of the character mask at the character location.

18. The method of claim 17, further comprising:
generating a circuit board based on the defined locations for the plurality of electrodes for each of the one or more character locations.

19. The method of claim 18, further comprising:
receiving display information from an input device; and
displaying a message on an electric writeable display adjacent to the circuit board by providing power to electrodes on the circuit board, wherein the displayed message corresponds to the display information received from the input device.

20. The method of claim 17 wherein each segment is separated from its adjoining segments by at least approximately 0.015 inches.

21. The method of claim 17 wherein each segment has an internal diameter of at least approximately 0.011 inches.
